(19) United States
(12) Patent Application Publication
(10) Pub. No.: US 2007/0063888 A1
(43) Pub. Date: Mar. 22, 2007

(54) Single side band radar

(75) Inventor: Alan Jenkins, Groton, MA (US)

Correspondence Address: Tyco Technology Resources, Suite 140, 4550 New Linden Hill Road, Wilmington, DE, 19808-2952, US

(73) Assignee: M/A-COM, Inc., Lowell, MA (US)

(21) Appl. No.: 11/232,615

(22) Filed: Sep. 22, 2005

(51) Int. Cl. G01S 13/08

(52) U.S. Cl. 342/70; 342/21; 342/118; 342/109; 342/195

(57) ABSTRACT

A pulsed radar that uses a single sideband pulsed signal for determining a distance to a target. The radar has twice the target resolution of a conventional pulsed radar using the same bandwidth signal. The single sideband pulsed signal may be produced by mixing a base-band pulsed signal with a radio frequency (RF) carrier frequency and then filtering the resultant amplitude modulated signal to suppress either the upper or the lower sideband signal. Because only one sideband is used, the pulse occupies half the bandwidth that it would in a conventional pulsed radar. For a given bandwidth, the single sideband radar, therefore, has twice the target resolution of a conventional pulsed radar system. The single sideband signal's shape must, however, be preserved during amplification to avoid reintroduction of the suppressed sideband, so highly linear power amplifiers must be used to boost the strength of the signal before transmission.

### FIELD OF THE INVENTION

The present invention relates to pulsed radar systems and methods, and more particularly to pulsed radar systems and methods having an improved resolution-to-bandwidth ratio.

### BACKGROUND OF THE INVENTION

Pulsed radar systems are well-known systems used for detecting the range and velocities of targets.

In a conventional pulsed radar system, a radio frequency (RF) carrier signal is modulated with a series of square, base-band pulses to produce an output signal having the carrier frequency and two sidebands produced by the modulation. The output signal is amplified using a power amplifier and the resultant high power, RF signal is transmitted via a transmitting antenna. A receiving antenna captures any of the transmitted signal that is reflected back off a target. The reflected signal is down-converted to a base-band pulse, and the time and phase difference between the transmitted pulse and the reflected pulse is determined. As the transmitting and receiving antenna are typically co-located, this time and phase difference can be used to determine the distance from the antenna to the target. Frequency shifts of the return pulse can be used to determine the velocity of the target relative to the antenna.

In a simple, pulsed radar system, the accuracy of the antenna-to-target distance measurement (also known as the target resolution) is inversely proportional to the width of the transmitted pulse. In turn, the bandwidth of the output signal is inversely proportional to the width of the transmitted pulse, so that the target resolution of a pulsed radar system is directly proportional to the bandwidth of the radar. In particular, the narrower the pulses used, the more accurately the antenna-to-target distance can be measured, i.e., the higher the target resolution of the radar. The tradeoff for the higher resolution is, however, that the signal bandwidth must be proportionally larger, i.e., a proportionally larger amount of frequency spectrum must be used.

Traditionally, radars have been developed for government agencies such as the military or the civilian air traffic control, both of which enjoy considerable latitude in use of the radio spectrum, both in terms of bandwidth and power use.

Recently, there has been a significant amount of interest in developing and deploying radar for civilian applications such as automobile radar. In these uses of radar, the constraints on bandwidth and power are much more restrictive, leading to radar developers having new and different design constraints. In particular, there is a need for high resolution radar systems, apparatus and methods that maximize the use of limited bandwidth, and use minimal power to avoid interference with electronic devices.

### SUMMARY OF THE INVENTION

The present invention relates to radar methods and systems that operate by combining a radio frequency carrier signal with a base-band, pulse signal, to generate a non-constant envelope, single-sideband signal. The single-sideband signal may then be used in determining a distance to a target. In a preferred embodiment, the radar system includes circuits for generating the radio frequency carrier signal, the base-band, pulse signal and for combining them to produce the non-constant envelope, single-sideband signal, as well as a circuit for determining the distance to a target using the single-sideband signal.

These and other features of the invention will be more fully understood by references to the following drawings.

### BRIEF DESCRIPTION OF THE DRAWINGS

FIG. 1 is a schematic drawing showing the main elements of an exemplary pulsed radar system.

FIG. 2A is a schematic drawing showing, in frequency space, a signal having two sidebands.

FIG. 2B is a schematic drawing showing the amplitude of the signal of FIG. 2A as a function of time.

FIG. 3A is a schematic drawing showing, in frequency space, a signal having a single sideband in frequency space.

FIG. 3B is a schematic drawing showing the amplitude of the signal of FIG. 3A as a function of time.

FIG. 4 is a schematic drawing showing a general form of the single sideband pulsed radar transmitter of the present invention.

FIG. 5 is a schematic drawing showing an implementation of the single side band pulsed radar transmitter of the present invention.

FIG. 6 is a schematic drawing showing the single side band pulsed radar transmitter using a base-band Hilbert transform.

### DETAILED DESCRIPTION

The present invention concerns systems, methods and apparatus for a radar system that makes efficient use of bandwidth and power by utilizing the technique of single sideband modulation. By using a single sideband signal, the radar of this invention has a target resolution that is twice the target resolution of a conventional radar operating with a signal having the same bandwidth.

In a preferred embodiment, the single-side band signal is produced by appropriate filtering of the carrier signal after mixing with the base band pulse signal. In particular, an appropriate base-band radar pulse signal is mixed with a radio frequency (RF) carrier signal, resulting in an amplitude modulated signal having the carrier frequency and a lower and an upper sideband signal. The lower sideband may then be suppressed to provide a single sideband signal that may be used in a radar application. In a preferred embodiment, the lower sideband is suppressed by an appropriate high-pass filter.

Because only one sideband is used in the single sideband radar pulse signal, a pulse of a given width only occupies half the bandwidth that an equivalent width pulse would occupy in a conventional pulsed radar application. For a given bandwidth use, the single sideband radar of this invention has, therefore, twice the target resolution of a conventional pulsed radar system.

The shape of the single sideband signal must, however, be preserved during any amplification to avoid reintroduction of the suppressed sideband. This requires that any power amplifiers used to boost the signal for transmission must be highly linear, or that the signal must be pre-distorted prior to amplification to compensate for any non-linearity in the power amplifiers.

These and other features of the invention will now be described in more detail with reference to the accompanying drawings in which, as far as possible, like numbers represent like elements.

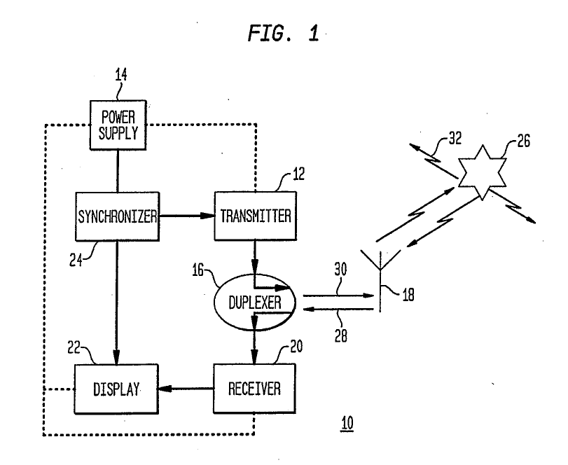

FIG. 1 is a schematic drawing showing the main elements of an exemplary pulsed radar system 10 having a co-located transmit and receive antenna. The radar system comprises a transmitter 12, a power supply 14, a duplexer 16, an antenna 18, a receiver 20, a display 22 and a synchronizer 24, and being used to send a pulse modulated RF signal 28 in the direction of a target 26. The radar system collects the fraction 30 of the reflected signal 32 as the return signal.

The transmitter 12 is a suitably high power radio frequency (RF) transmitter modulated at the appropriate pulse width for the pulsed radar.

The receiver 20 is a suitably sensitive RF receiver that can receive the small return signal 30 reflected off target 26.

The duplexer 16 is a device that allows radiation from the transmitter to be fed to the antenna but not to the receiver, and similarly for radiation from the antenna to be fed to the receiver but not to the transmitter.

The pulsed radar system operates by the transmitter 12, under the control of the synchronizer 24, sending a pulse modulated signal via the duplexer 16 out from antenna 18 in the direction of the target 26. Although most of the signal reflected from the target 26 is directed into signals 32 that do not return to the transmitting antenna 18, a small portion of the transmitted signal 28 is returned to the antenna 18 as the return signal 30. The return signal 30 is detected by being fed via the duplexer 16 to the receiver 20 and on to the display 22. In the exemplary system of FIG. 1, the display is controlled by the synchronizer 24, allowing the display 22 or suitable electronic circuitry associated with it, to measure time and frequency differences between the transmitted signal and received signal and to make target range and velocity measurements.

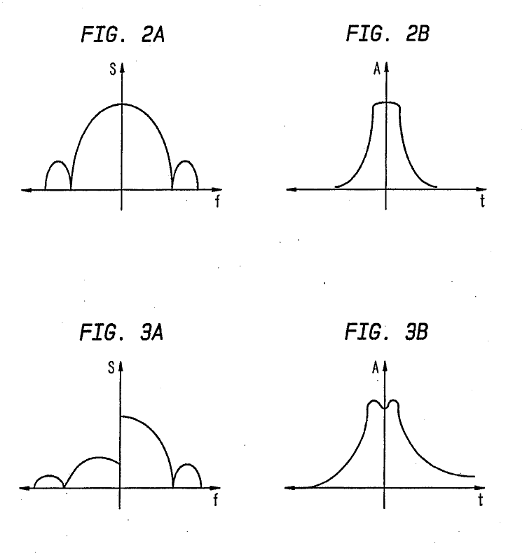

FIG. 2A is a schematic drawing showing, in frequency space, a signal having two sidebands. The strength S of the signal is plotted logarithmically in dB against frequency.

FIG. 2B is a schematic drawing showing the amplitude of the double sideband signal of FIG. 2A plotted linearly as a function of time. The signal is symmetrical, and is essentially a constant envelope signal so that any distortions in the power amplifier have a minimal effect on the signal.

FIG. 3A is a schematic drawing showing, in frequency space, a signal having a single sideband. The strength S of the signal is plotted logarithmically in dB against frequency.

FIG. 3B is a schematic drawing showing the amplitude of the single sideband signal of FIG. 3A plotted linearly as a function of time. The signal is asymmetrical and has an amplitude shape structure (also known as magnitude ripple) that needs to be maintained in order to preserve the single sideband characteristic of the signal, i.e., it is important that an amplified signal is congruent with the original single sideband signal. Amplification of the single sideband signal by a non-linear amplifier will distort the shape of the signal and grow back the suppressed sideband.

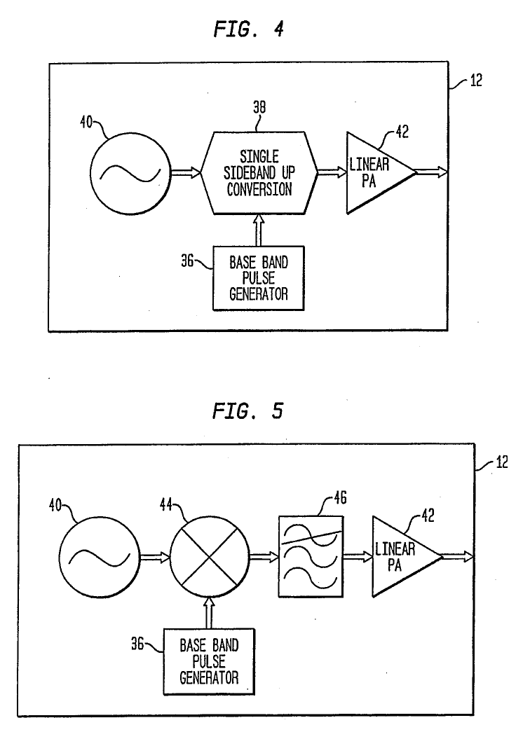

FIG. 4 is a schematic drawing showing a general form of the single side band pulsed radar transmitter of the present invention. The transmitter 12 comprises a base-band pulse generator 36, a single sideband up converter 38, a carrier frequency generator 40 and a linear amplifier 42.

The base-band pulse generator 36 produces a signal that is a series of essentially rectangular pulses. The single sideband up converter 38 mixes the base-band pulse signal with a sinusoidal RF carrier frequency signal from the carrier frequency generator 40 to produce a single sideband signal, as shown in FIG. 3A, and having an asymmetrical modulation envelope of the form shown in FIG. 3B. The single side band signal is then amplified by a linear power amplifier 42 and fed to the radar antenna 18. As discussed above, because the single side band signal is not a constant envelope signal, it is important that power amplifier 42 be linear so that the amplitude information of the waveform is preserved and there is no re-growing of the spectral content of the waveform.

FIG. 5 is a schematic drawing showing an implementation of a single sideband pulsed radar transmitter in accordance with the present invention. The transmitter 12 comprises a base-band pulse generator 36, a carrier frequency generator 40, a mixer 44, a high-pass filter 46 and a linear amplifier 42. The mixer 44 mixes the base-band pulse signal with a sinusoidal carrier frequency signal from the carrier frequency generator 40 to produce a signal having two sidebands, as shown in FIG. 2A, and a symmetrical modulation envelope of the form shown in FIG. 2B. This double sideband signal is then fed through a high-pass filter 46 to suppress the lower sideband and produce a single sideband signal, as shown in FIG. 3A, and having an asymmetrical modulation envelope of the form shown in FIG. 3B. The single sideband signal is then amplified by a linear power amplifier 42 and fed to the radar antenna 18.

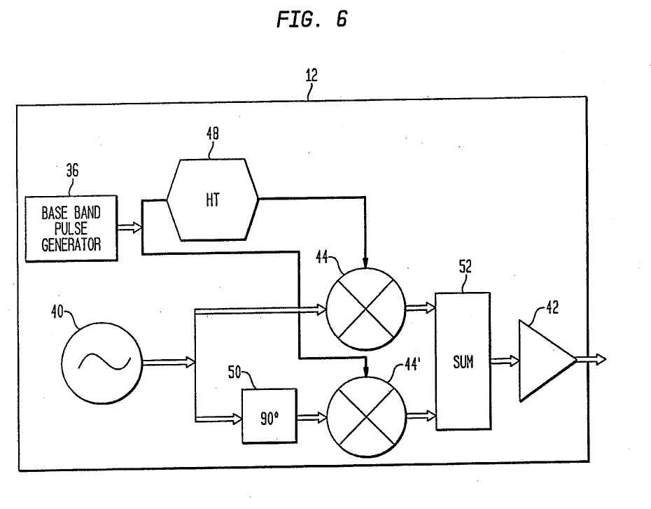

FIG. 6 is a schematic drawing showing the single sideband pulsed radar transmitter in accordance with an alternative embodiment of the invention using a base-band Hilbert transform. The transmitter 12 comprises a base-band pulse generator 36, a carrier frequency generator 40, a Hilbert Transform module 48 a 90 degree phase shifter 50, two mixers 44, a summation module 52 and a linear power amplifier 42.

A signal from the base-band pulse generator is split into two, with one copy of the signal being fed through the Hilbert transform module 48 to a first mixer 44 while the other part of the signal is fed directly to the second mixer 44. The carrier signal from the carrier frequency generator 40 is similarly split in two with one copy fed to the first mixer 44 and the second copy phase shifted by 90 degrees before being fed to the second mixer 44. The first mixer 44 mixes the Hilbert transformed base-band pulse signal with a carrier signal, while the second mixer 44 mixes the base-band pulse signal with a 90 degree phase shifted carrier signal. The outputs of the two mixers 44 are summed to form a single side band signal which is fed to the linear power amplifier 42.

The Hilbert transform module may be, but is not limited to, any suitably programmed general purpose digital signal processing circuit, or a hardware implementation of the processing steps of such programming.

The Hilbert transform circuit of FIG. 6 performs a task that is similar in principle to quadrature upconversion, in which two mixers are driven with sine and cosine local oscillators (LOs), which are internally derived from a single-ended high-quality oscillator. The mixers are also fed sine and cosine base-band signals to be up-converted symmetrically about the fixed LO. The two mixer outputs are summed to add in-phase components and reject quadrature components. The end result is a suppressed-carrier, single-sideband, voltage output at a frequency that is either the sum or difference of the LO and baseband signal, plus suppressed remnants of the LO and opposing sideband.

Such a system can be thought of in terms of the double angled sine formula in reverse, i.e.,
sin A cos B+A sin B=(A+B)

where sinA represents the carrier frequency, cosA represents the carrier frequency phase shifted by 90 degrees, sinB represents one component of the pulse signal, and cosB represents that component phase shifted by 90 degrees. The single output, sin(A+B) represents the single side band, carrier suppressed output signal.

As the Hilbert transform of a real signal is a complex signal in which the real part is the original signal and the imaginary part is a 90 degree phase shifted version of the original signal, an alternative way to implement quadrature upconversion is to Hilbert transform both the base-band pulse generator signal and the carrier signal. The real part from one Hilbert transform is then mixed with the imaginary part of the other Hilbert transform, and vice versa, and the output of the two mixers summed, with the result being a single sideband output signal.

In a further embodiment of the invention, a power amplifier having some distortion may be used, so as to maximize the efficiency of the system. In this case, the single sideband signal is pre-distorted so that, after amplification by the non-linear amplifier, the signal maintains the single side band, and there is no re-growing of the spectral content of the waveform. This requires that the power amplifier has distortion characteristics that are complementary to the pre-distortion of the single sideband signal, so that the amplified signal has an amplitude shape that is congruent with the original, single sideband signal. The pre-distortion of the signal may be done by, but is not limited to, a suitably programmed general purpose digital signal processing circuit, or a hardware implementation of the processing steps of such programming.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention

1. A radar method, comprising the steps of:
combining a radio frequency carrier signal with a base-band, pulse signal, to generate a non-constant envelope, single-sideband signal; and
determining a distance to a target using said single-sideband signal.

2. The method of claim 1 wherein said step of determining said distance to said target comprises the steps of transmitting said single sideband signal from a first antenna; detecting said single sideband signal after reflection off a target using a second antenna; and measuring a time delay between said transmitting and detecting, said time delay time being indicative of said distance to said target.

3. The method of claim 2 wherein said first and second antenna are co-located.

4. The method of claim 3 wherein said step of combining comprises the steps of mixing said radio frequency carrier signal and said base-band, pulsed signal to provide an amplitude modulated signal having said carrier frequency and a lower and an upper sideband signal; and suppressing one of said sidebands of said amplitude signal using a high-pass filter.

5. The method of claim 3 wherein said step of combining comprises Hilbert transforming said carrier signal to provide a first transformed signal; Hilbert transforming said pulse signal to provide a second transformed signal; mixing a real part of said first transformed signal with an imaginary part of said second transformed signal to provide a first mixed signal; mixing an imaginary part of said first transformed signal with a real part of said second transformed signal to provide a second mixed signal; and summing said first and second signal to provide said single-sideband signal.

6. The method of claim 1 further comprising the step of amplifying said single sideband signal using a linear amplifier, thereby preserving the amplitude shape of said single sideband signal.

7. The method of claim 1 further comprising the step of pre-distorting said single sideband signal and amplifying said pre-distorted signal using an amplifier having distortion characteristics complementary to said pre-distortion, thereby providing an amplified signal having an amplitude shape congruent with said single-sideband signal.

8. A radar system, comprising:
a circuit for generating a radio frequency carrier signal;
a circuit for generating a base-band, pulse signal;
a circuit for combining said carrier signal and said pulse signal to produce a non-constant envelope, single-sideband signal; and
a circuit for determining a distance to a target using said single-sideband signal.

9. The system of claim 8 wherein said circuit for determining a distance to said target further comprises a first antenna for transmitting said single sideband signal; a second antenna for detecting said single sideband signal after reflection off a target; and a circuit for measuring a time delay between said transmitted signal and said detected signal, said time delay being indicative of a distance to said target.

10. The system of claim 9 wherein said first and second antenna are co-located.

11. The system of claim 9 wherein said circuit for combining said carrier signal and said pulse signal comprises a mixer and a high pass filter.

12. The system of claim 9 wherein said circuit for combining said carrier signal and said pulse signal comprises a first Hilbert transform circuit for transforming said carrier signal to provide a first transformed signal; a second Hilbert transform circuit for transforming said pulse signal to provide a second transformed signal; a first mixer for mixing a real part of said first transformed signal with an imaginary part of said second transformed signal to provide a first mixed signal; a second mixer for mixing an imaginary part of said first transformed signal with a real part of said second transformed signal to provide a second mixed signal; and a summation circuit for summing said first and second signal to provide said single-sideband signal.

13. The system of claim 8 further comprising a linear amplifier for amplifying said single sideband signal, thereby preserving the amplitude shape of said single sideband signal.

14. The system of claim 8 further comprising a power amplifier and a pre-distortion circuit for pre-distorting said single sideband signal prior to amplification by said power amplifier, thereby providing an amplified signal having an amplitude shape congruent with said single-sideband signal.

15. A radar apparatus, comprising:
combination means for combining a radio frequency carrier signal with a base-band, pulse signal, to generate a non-constant envelope, single-sideband signal; and
determination means for determining a distance to a target using said single-sideband signal.

16. The apparatus of claim 15 wherein said determination means further comprises a first antenna means for transmitting said single sideband signal; a second antenna means for detecting said single sideband signal after reflection off a target; and comparison means for measuring a time delay between said transmitting and detecting, said time delay being indicative of said distance to said target.

17. The apparatus of claim 16 wherein said combination means further comprises mixer means for mixing said radio frequency carrier signal and said base-band, pulsed signal to provide an amplitude modulated signal having said carrier frequency and a lower and an upper sideband signal; and filtering means for suppressing one of said sidebands of said amplitude signal.

18. The apparatus of claim 16 wherein said combination means further comprises a first Hilbert transform means for transforming said carrier signal to provide a first transformed signal; a second Hilbert transform means for transforming said pulse signal to provide a second transformed signal; a first mix means for mixing a real part of said first transformed signal with an imaginary part of said second transformed signal to provide a first mixed signal; a second mix means for mixing an imaginary part of said first transformed signal with a real part of said second transformed signal to provide a second mixed signal; sum means for summing said first and second signal to provide said single-sideband signal.

19. The apparatus of claim 15 further comprising a linear amplification means for amplifying said single sideband signal, thereby preserving the amplitude shape of said single sideband signal;

20. The apparatus of claim 15 further comprising a pre-distortion means for pre-distorting said single sideband signal; and amplification means for amplifying said pre-distorted signal, thereby providing an amplified signal having an amplitude shape congruent with said single-sideband signal.

21. The method of claim 1 wherein said step of combining comprises:
Hilbert transforming said pulse signal to provide a first transformed signal; transforming via phase shifting said carrier signal to provide a second transformed signal; mixing said first transformed signal with said carrier signal to provide a first mixed signal; mixing said second transformed signal with said pulse signal to provide a second mixed signal; and summing said first and second signal to provide said single-sideband signal.

22. The radar system of claim 8 wherein said circuit for (38) combining said carrier signal and said pulse signal comprises:
a Hilbert transform circuit (48) for transforming said pulse signal to provide a first transformed signal;
a phase shifter (50) for transforming said carrier signal to provide a second transformed signal;
a first mixer (44) for mixing said first transformed signal with said carrier signal to provide a first mixed signal;
a second mixer (44′) for mixing said second transformed signal with said pulse signal to provide a second mixed signal; and
a summation (52) circuit for summing said first and second signal to provide said single-sideband signal.
